(19) United States
(12) Patent Application Publication
(10) Pub. No.: US 2024/0359042 A1
(43) Pub. Date: Oct. 31, 2024

(54) REUSABLE ADAPTOR FOR FIT TESTING PARTICULATE OR GAS AND PARTICULATE PROTECTION FACEMASKS/RESPIRATORS

(71) Applicant: GVS S.P.A., Zola Predosa (IT)

(72) Inventors: Ondrej KALENSKY, Lancaster (GB); Ben James HARTROPP, Cumbria (GB)

(21) Appl. No.: 18/291,207

(22) PCT Filed: Jul. 8, 2022
(86) PCT No.: PCT/IB2022/056335

§ 371 Date: Jan. 22, 2024

(30) Foreign Application Priority Data
Jul. 22, 2021 (IT) 102021000019430

(51) Int. Cl. A62B 27/00

(52) U.S. Cl. CPC A62B 27/00

(57) ABSTRACT

An adaptor to allow fit testing a particulate or gas and particulate protection facemask/respirator, the adaptor having an adaptor body configured to couple with an exhalation valve of the facemask. The adaptor body includes a protruding first sampling tube adapted to connect to a known facemask fit testing device, the first sampling tube being able to be connected to a second adaptor sampling tube inside the facemask passing through the exhalation valve.

### RELATED APPLICATIONS

The present disclosure is a § 371 of international PCT Application No. PCT/IB2022/056335, filed Jul. 8, 2022, which claims priority to Italian Application No. 102021000019430, filed on Jul. 22, 2021, the entire contents of each of which are incorporated herein by reference in their entirety.

### FIELD

The present disclosure relates to an adaptor for testing the suitability of a facemask/respirator to a particular user for protection against particulate contaminants (solid and liquid hazardous and toxic dust particles, metal fumes, mist and micro- organisms, e.g. bacteria or viruses) and gas and particulate contaminants.

### BACKGROUND

The aforementioned protection facemasks are usually facemasks that cover only half of the user's face (half masks) and that leave the eyes free, or masks that completely cover this face, including the user's eyes (full face masks or half masks with goggle). They comprise a structure adapted to position itself on the user's face; the structure has yielding edges which rest on this face and which seal on it, and comprises straps adapted to allow to keep the mask fixed on the face of the user, whatever movement he may perform. Both the half-face and full-face protective masks include at least one central non-return valve, with diaphragm, for exhalation by the user and at least one or two side valves, equipped with filters, for suction air from the user.

The protection facemasks must be tested (using a known device or “Quantitative Fit Tester”) in order to prove their suitability for each user. To obtain this test, various solutions are known: one of them comprises a sampling tube inserted through a special filter used to replace a corresponding filter of the facemask and which is connected to the well-known test device (“Quantitative Fit Tester”) which tests the possibility that the protection facemask can be used by a particular user (with the necessary adjustments of the straps), checking the tightness of the facemask around the user's face. These known solutions are somewhat complicated and require manual intervention and processing which leads to high costs, longer set up times and difficulty in positioning the sampling tube within the face piece to the required position for Fit Testing.

Another solution always provides for the use of a tube that passes inside an exhalation valve after its function has been disabled; in this case, however, the protection facemask is of the type with two exhalation valves, so disabling one of them to perform the test (“Fit Test”) does not make it impossible to carry out the test.

U.S. Pat. No. 4,146,025 describes a device for testing the tightness of fit of a gas mask which has a tubular respiratory air inlet and a tubular exhaling air outlet, the facemask being applied over the face of a wearer. The device comprises a bag-like headpiece which is engageable over the wearer's head and is preferably made of a transparent material, such as plastic. The headpiece is provided with an opening for the wearer's neck and an opening for the tubular air inlet of the gas mask with a resilient rim for tightly engaging these parts when the headpiece is positioned on the wearer's head.

The headpiece also includes a tubular exhaling air connection piece which is formed on the interior of the headpiece in a position to be engaged over the tubular exhaling air outlet of the gas mask.

The connection piece includes an uptake passage for the passage of air directly from the mask outwardly through the passage.

The passage may be connected to a measuring bag for collecting the air for its subsequent passage through a measuring tube to determine the quantities of testing gas which are present in the respiratory air, said testing gas being entered in the headpiece over the wearer's head.

This prior document relates to a device which is suitable for testing gas mask only, but it is not suitable to test a mask for particulate: it should be noted that particulate and gas particles are different in size and different mechanisms for their filtration are required. Moreover, the known solution does not describe the use of filters in place on the mask during testing nor consider the use of the exhalation valve operation on the gas mask.

It is important to note that the prior document is able to sample the air that is exhaled from the mask (and taken from the environment), but it cannot sample the air when it is inside the mask. Sampling exhaled air is somewhat limiting and not accurate due to a phenomenon of “dead space”; that is the possibility that not all air from the facemask is exhaled at once during the test.

Therefore, the sampling of the gas input into the headpiece located on the user's head and inside the exhaled air (entered into the facemask from a sealing frame around the wearer face) cannot be effectively accurate.

U.S. Pat. No. 7,594,426 describes an adapter to connect a portable testing device known as the Joint Service Mask Leakage Tester (JSMLT) to the outlet valve body of a protective mask such as the M45 mask.

The adapter has two separate components, with one inner component and an outer component, where the inner component is connected and seals to a portion of the outlet valve body located outside the facemask.

Said solution does not provide any air sampling from the inside of the facemask.

### SUMMARY

The present disclosure provides an adaptor for testing the suitability of a protection facemask for each user to ensure the correct functionality against particulate (solid and liquid hazardous and toxic dust particles, metal fumes, mist and micro-organisms, e.g. bacteria or viruses) or gas and particulate contaminants of the aforementioned type which allows a direct test of the functionality of the mask without compromising its sealing on the face and without making any specific adaptation to the mask for the implementation of the test.

An fobject is to provide an adaptor of the aforementioned type which does not involve any modification to the filtration performance of the facemask.

A further objective is to provide an adaptor of the aforementioned type which allows to perform the fit test of the protection facemask through the use of the exhalation valve present on the mask, said test permitting to take the air from the inside of the facemask as recommended by best practice.

Another objective is to provide an adaptor of the aforementioned type which is simple to attach to the facemask and which allows rapid connection of the facemask to the device for testing its functionality when fitted on the user's face (“Quantitative Fit Test”).

A further object is to provide an adaptor of the aforementioned type whose positioning on the facemask (with each of its parts) is simple and which simplifies the implementation and increases the reliability and accuracy of the test.

These and other objects which will be evident to the skilled in the art are achieved by an adaptor according to the appended claims.

### BRIEF DESCRIPTION OF THE DRAWINGS

For a better understanding of the present disclosure, the following drawings are attached purely by way of non-limiting example, in which:

FIG. 1 is a perspective view of a first embodiment of an adaptor according to the disclosure;

FIG. 2 is a perspective view of a second embodiment of the present disclosure;

FIG. 3 is a cross-sectional perspective view of the adaptor of FIG. 1;

FIG. 4 is an exploded perspective view of the adaptor of FIG. 2 during the coupling with a facemask able to cover only part of the user's face;

FIG. 5 is a detailed, close-up and cross-sectional perspective view of an adaptor according to the disclosure coupled to the facemask of FIG. 4;

FIG. 6 is a perspective view of the inside of the facemask of FIG. 4 provided with the adaptor according to the disclosure;

FIG. 7 is a front perspective view of the facemask of FIG. 6, provided with the adaptor according to the disclosure; and

FIG. 8 is an exploded, perspective view of the adaptor of FIG. 2 and the facemask, similar to FIG. 4 but taken from a different view.

### DETAILED DESCRIPTION

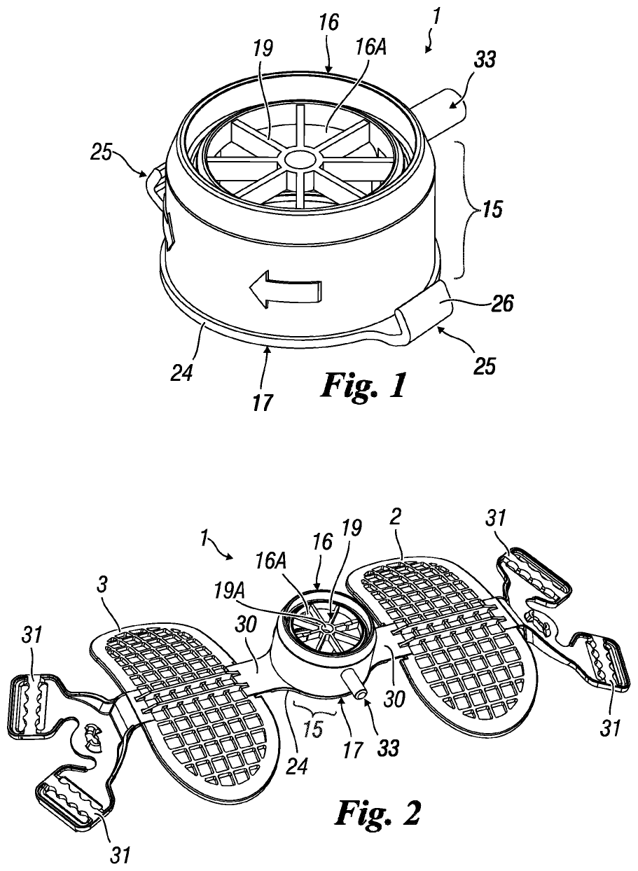

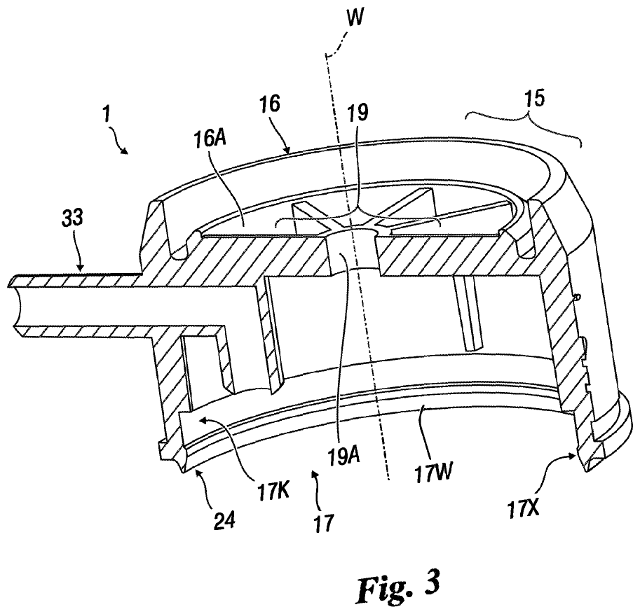

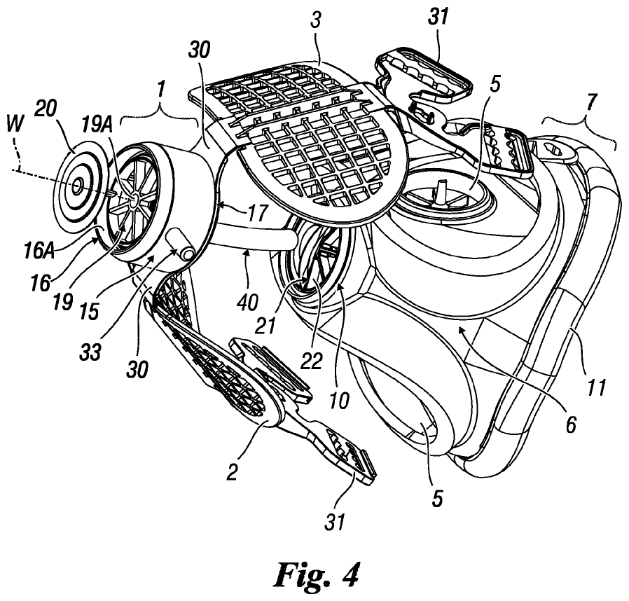

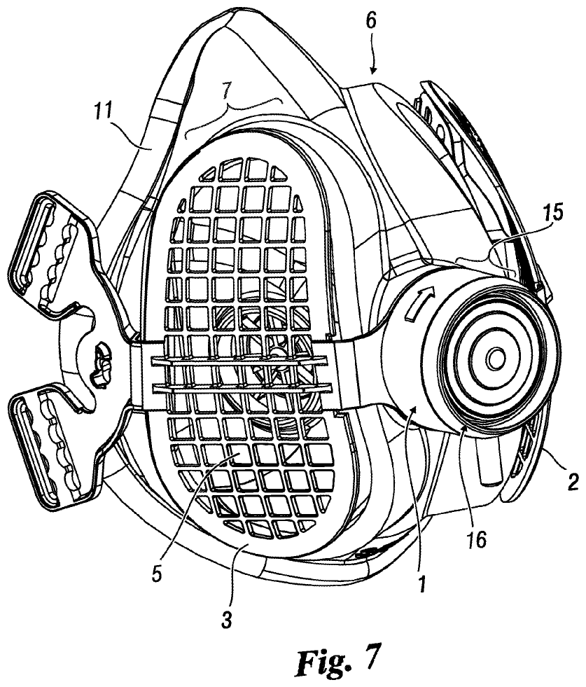

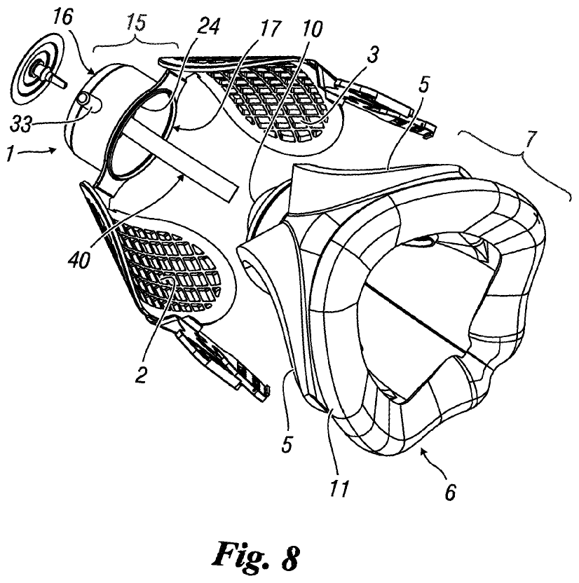

With reference to the aforementioned figures, an adaptor 1 according to the disclosure is represented in two embodiments: in FIG. 1, the adaptor is suitable to be connected with a face mask of the type with activated carbon and particulate filter; in FIGS. 2-8, the adaptor is associated with lateral bodies 2 and 3, provided with grids, adapted to overlap lateral suction filters (not shown) placed in seats 5 of a body 6 of a facemask 7 (see, for example, FIG. 4). The adaptor is shown on a half mask, but the facemask 7 can be of the “full face” type and may also include glasses suitable for covering the user's eyes.

The body 6 of the facemask 7 also comprises a central exhalation valve 10 (known per se) and an edge 11 having a yielding coating suitable for resting on the user's face so as to seal it when the facemask is worn. Usual straps, not shown, tie the facemask to the aforementioned face.

The adaptor 1 comprises a cup-shaped body 15 that is cylindrical and has opposite open ends 16 and 17. A radial structure 19 is placed at the first end 16 and inside a hole 16A present in correspondence with it, adapted to support a diaphragm 20 with a tail 20A inserted in a central hole 19A of this radial structure 19, inside the body 15 of the adaptor 1 and along a longitudinal axis W of the latter. The tail 20A faces a structure 21 of the exhalation valve 10 (also in a radial pattern) in the direction of a perforated central part 22 of this structure.

At the second end 17, open at 17W, the cup-shaped body 15 has a free edge 24 delimiting this opening 17W and shaped as a triangle that bears on body 6 of the facemask 7 in order to create a seal on it. In the embodiment of FIG. 1, from this edge the fins 25 project (towards the outside of the adapter 1) with ends 26 bent towards the first end 16 of the body 15. The bent fins 25 are adapted to provide the attachment for activated carbon and particulate filter (not shown). The engagement with the exhalation valve 10 is created by a snap fit; as shown in the embodiment of FIGS. 2-8, the fastening of the body 15 to the valve 10 takes place by direct coupling between a free end 10A of this valve and a recess 17K provided internally at the end 17 of the body 15 of the adaptor 1. A projecting ring or annular portion 17X is located close to edge 24 of body 15 and snap fits with valve 10.

In the embodiment of FIGS. 2-8, from the free edge 24 project two opposing wings 30 associated with the bodies 2 and 3, provided with grids, suitable to overlap the filters present (but not shown in the figures) in the seats 5. These bodies provided with grids are associated with buckles 31 for fastening straps (not shown) to the body 6 of the facemask 7 to allow a user to wear and adjust the facemask.

In the embodiment of FIGS. 2-8, the cup-shaped body 15 does not have the bent fins 25 of the embodiment of FIG. 1.

It should be noted, however, that in each embodiment the facemask 7 associated with the adaptor 1 has the known structure 21 of the exhalation valve 10 (normally already present on the facemask).

Finally, it should be noted that the adaptor 1 makes a direct seal on the facemask body 7 by means of free edge 24.

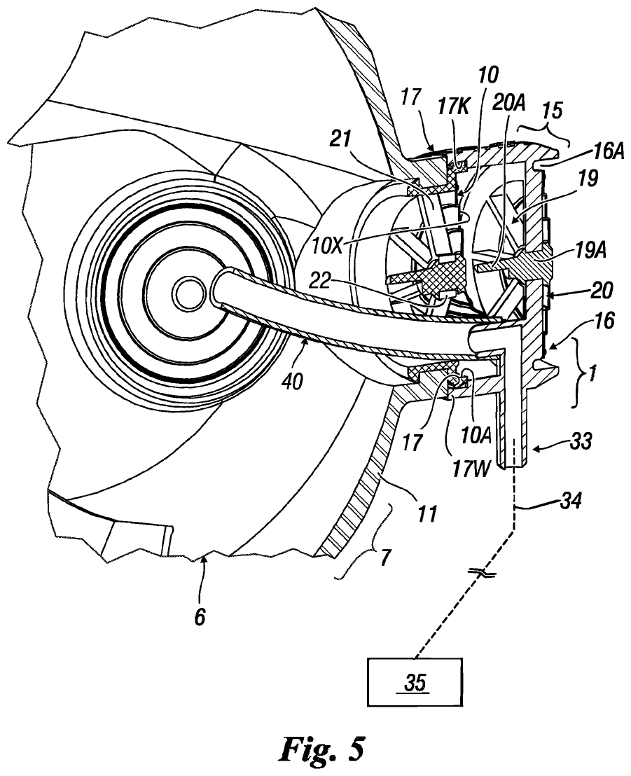

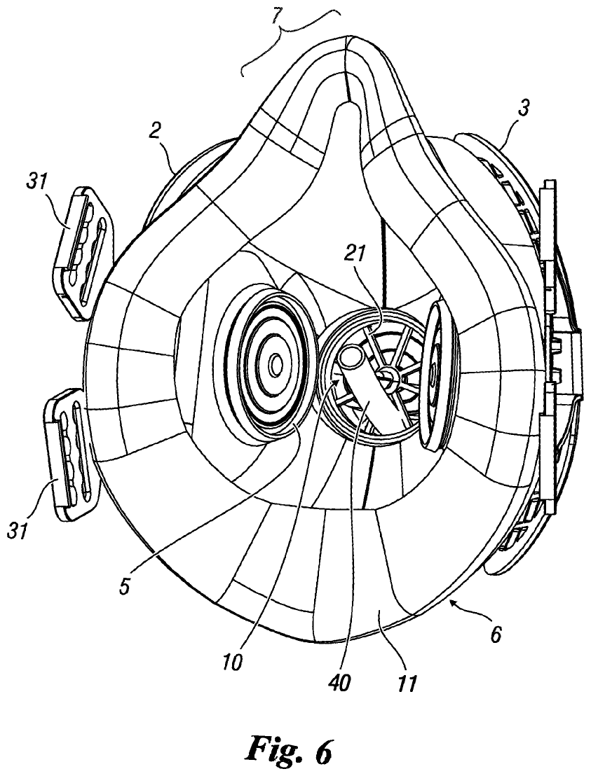

A first sampling tube or duct 33 extends laterally from the body 17 of the adaptor and is adapted to be connected, by means of a usual connection tube 34, to a known machine (“Quantitative Fit Tester”) 35 suitable to test the suitability of the mask on the face of a user (“Fit Test”). The connection tube 34 and the Fit Tester 35 are shown only indicatively in FIG. 5.

This first sampling tube or duct 33 (L-shaped) is connected with a second sampling tube 40, which is always a portion of the adaptor and is preferably flexible, which ends inside the mask 7 and directly receives the air exhaled by the user who wears the facemask during the compliance fit test. This permits to sample the air inside the facemask and to overcome the limits of the tests carried out on the air exiting from the facemask and containing a test gas entering from the side frame of said facemask: sampling this exiting air may give erroneous results due to the phenomenon of “dead space” linked to the possibility that not all air from the facemask is exhaled at once. Sampling air from the centre of or in any case inside the facemask overcomes said risk; this is permitted by the (second) adaptor sampling tube 40 connected to the (first) sampling tube or duct 30. The L-shape of this first tube permits to limit the adaptor dimensions on the facemask and permits to direct the second sampling tube 40 inside the facemask.

The sampling tube 40 passes through a known diaphragm 10X of the central exhalation valve 10 to reach the inside of the facemask, without the need to separate said valve 10 from the body 6 of the facemask. Adaptor 1 features an exhalation valve identical to the exhalation valve 10 of the facemask and while conducting the test of the faceseal tightness, this valve is in a normal operation. The ideal position reached by the tube 40 is at 10 mm from the user's face, in between his/her mouth and nose.

Obviously, the adaptor 1 is coupled to the facemask 7 always so as to seal on the body 6 of the facemask.

Thanks to the disclosure it is possible to quickly and simply associate the adaptor 1 to the facemask 7 to test its functionality with a test (“Fit Test”) known per se and taking air directly from the inside of the facemask. This is achieved without removing any filtration component from the mask. In this way it is possible to obtain a functionality test which is truly representative of the quality of the sealing of the mask on the user's face (because the air is taken directly from the inside of the facemask) while maintaining the mask in a conformation and position of usual use.

Two specific embodiments of the disclosure have been described. The person skilled in the art, in view of the above description, will however be able to obtain other embodiments which fall within the scope of the disclosure defined by the following claims.

1. An adaptor to allow fit testing the suitability of solid and liquid hazardous and toxic dust particles, metal fumes, mist and micro-organisms, bacteria or viruses or a gas and particulate protective facemask/respirator, the facemask having at least one exhalation valve, said adaptor comprising:
an adaptor body adapted to sealingly couple with said exhalation valve of the facemask, said adaptor body including a first sampling tube protruding from said body and connected to a second sampling tube which passes through the exhalation valve of the facemask and ends inside said facemask and configured to allow the air inside to the facemask to be sampled, the suitability of the facemask being tested through the first sampling tube.

2. The adaptor according to claim 1, wherein the adaptor body is reusable.

3. The adaptor according to claim 1, wherein said adaptor body cylindrical and cup-shaped and includes a first end and a second end opposite the first end, the second end comprising a through opening delimited by an edge and configured to cooperate directly with said exhalation valve and with the facemask body, said first end having a through hole.

4. The adaptor according to claim 1, wherein said adaptor body comprises fastening means configured to cooperate with the exhalation valve and facemask body to fasten said adaptor to said exhalation valve.

5. The adaptor according to claims 3, wherein said fastening means include an annular portion inside the adaptor body and projecting close to the edge and delimiting the opening of the second end of said adaptor body and adapted to snap-fit to the exhalation valve, a recess being provided inside said second end adapted to receive a free end of said exhalation valve.

6. The adaptor according to claim 3, wherein, at the through hole, the first end of the adaptor body comprises a radial structure, and a diaphragm is placed in said radial structure and is fixed to the adaptor body.

7. The adaptor according to claim 6, wherein the radial structure has a central hole in which a tail of the diaphragm is placed so as to constrain the latter to the adaptor body.

8. The adaptor according to claim 1, wherein the second adaptor sampling tube passes through a diaphragm of the exhalation valve.

9. The adaptor according to claim 8, wherein the second sampling tube is positioned at 10 mm from a user's face, in between his/her mouth and nose.

10. The adaptor according to claim 1, wherein the first sampling tube projects laterally to the adaptor body.

11. The adaptor according to claim 10, wherein said first sampling tube is L-shaped.

12. The adaptor according to claim 1, wherein the adaptor is coupled to a facemask comprising lateral suction filters, and wherein the adaptor includes lateral bodies, provided with grids, projecting from the adaptor body and configured to cover said lateral filters, said lateral bodies provided with grids being connected to buckles for usual straps of the facemask.

13. An assembly of a particulate or gas and particulate protection facemask and an adaptor according to claim 1, said facemask being of the half-face or full-face type and comprising an exhalation valve, wherein the adaptor body is adapted to be fixed directly to the exhalation valve, to perform a functionality test of the facemask, said adaptor comprising a second sampling tube which passes through the exhalation valve and coupled to a first sampling tube protruding from said adaptor body and connected to a machine for fit testing the suitability of the facemask for each user.
